(19) United States
(12) Patent Application Publication
(10) Pub. No.: US 2009/0171860 A1
(43) Pub. Date: Jul. 2, 2009

(54) Process for optimized lifetime return on personal investment capital or wealth creation

(75) Inventor: Robert T. Hoffman, Pennington, NJ (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: TOPP MARK LLC, Pennington, NJ (US)

(21) Appl. No.: 12/291,519

(22) Filed: Nov. 10, 2008

Related U.S. Application Data
(60) Provisional application No. 60/996,311, filed on Nov. 9, 2007.

(51) Int. Cl. G06Q 40/00

(52) U.S. Cl. 705/36 T

(57) ABSTRACT

A process for managing investment funds to realize the highest return after taxes. First and second distinct closed end funds are established. The first of said funds is a personal account (PA) fund designed to be purchased with taxable monies, and the second of said funds is a tax deferred (TD) fund designed to be purchased with tax deferred monies. A single investment manager is designated for the funds. The investment manager manages investments in the funds separately from each other, and makes buy and sell determinations on assets for each fund based on the manager's assessment of the prospective holding period of the asset and the characterization of income from and appreciation of the asset expected over time such that taxable gains and taxable income are minimized in the first fund. Tax losses are recognized in the first fund such that they can be employed to offset potential future gains, thereby realizing the minimum tax burden on investment returns from both funds in both long and short taxation periods.

### CROSS-REFERENCE TO RELATED APPLICATION

This application is related to and claims priority from U.S. Provisional Application Ser. No. 60/996,311 filed Nov. 9, 2007, the disclosure of which is incorporated herein by reference in its entirety.

### FIELD OF THE INVENTION

The present invention relates to the field of management of investment instruments. In particular, this invention addresses the optimization of long-term/lifetime returns realized from a pair of individually managed closed-end funds. The pair is referred to herein as “Total Optimized Portfolio Performance” (TOPP) funds or TOPP Funds.

### BACKGROUND OF THE INVENTION

The field of investment management offers myriad funds with differing objectives and investment strategies to choose from. Among an almost infinite array of choices investors can select growth funds to grow their investment nest egg quickly when the markets perform well on the up side, value funds whose objective is to pick stocks whose share values will increase slowly but steadily over time, income funds to provide a continuing return on investment, and tax sheltered funds to permit tax-free investing. While the range of funds presents a variety of investment opportunities, there is no fund group that gives the investor the ability to hire a single fund manager who then has the opportunity to allocate investment decisions between two recipient funds that, taken together, will optimize the long-term/lifetime return on investment capital for investors participating in both of the managed funds. It is this management niche that is addressed by the present invention.

### SUMMARY OF THE INVENTION

The process of the invention is directed to establishing a pair of closed end funds that, stock selection being equal, will realize the highest long term/lifetime return on personal investment capital invested in the fund pair. The first fund of the Total Optimized Portfolio Performance (TOPP) pair is hereinafter referred to as the “PAA Fund” (or merely PAA), which signifies that this fund is for “Personal Account Assets”. This fund will be used by the portfolio manager (PM) to place investments that are appropriate for a Personal Account, or currently taxed account. The second fund of the TOPP pair is hereinafter referred to as the “RAA Fund” (or merely RAA) which signifies that this fund is for “Retirement Account Assets”. This fund will be used by the PM to place investments that are more appropriate for a retirement, or tax-deferred account. A single investment manager (which can comprise one or more persons) is designated to manage both funds within the TOPP pair. This PM's primary decision is to determine what securities to buy and sell. If he were managing just one portfolio, or if there were no tax consequence to any purchase and sale of a security, then his buy and sell decisions would effectively be the same. The unique aspect of this invention is that it gives the PM two distinct conduits with which to optimize the execution of the investment ideas.

The constituent funds in the TOPP pair are managed separately from each other, as they are separately offered funds under the 1940 Act. After the PM has made a determination to buy or sell a security, his choice of the recipient fund (the PAA or RAA fund) is based on the manager's combined assessment of: the nature of the return profile of the security (income or capital appreciation); the security's risk reward characteristics (what is the projected upside opportunity versus the potential downside risk); and the expected time frame of that performance (the prospective holding period). This assessment has as its goal the optimization of long term wealth creation, which is partly a function of the minimization of the real tax burden on the sums invested in the TOPP Funds and on its gains, collectively. This includes minimizing current year taxes on expected gains while having the ability to offset potentially unforeseen gain taxes by optimizing the location of unforeseen security losses. The goal of the funds is also to maximize the combined compounding effect of long term holdings with the tax benefits accorded to such holdings.

Optimizing long term wealth creation within 2 closed end fund vehicles eliminates the destructive power of OPA risk. OPA, (which stands for Other Peoples Actions) refers to the effect on investment returns felt by investor A driven solely by the actions of people other than Investor A. The most dramatic example of OPA risk on an open end fund where Investor A has money, is the dilutive effects that Investor B's (or better stated Investor B, C, D . . . Z) actions can have on Investor A's wealth. Investor B putting money in can dilute the positions already held by the fund, while Investor B taking out funds can cause the fund to realize gains (by selling to raise cash). Depending upon the liquidity of the positions this selling can also drive down the value of the security(s) being sold. Avoiding OPA risk (a wealth optimization feature) can only be achieved through a closed end vehicle.

This invention is a wealth optimization process. With the TOPP Funds, the primary focus of the PM is to buy and sell the correct securities based on a professional evaluation of risk, reward, gain potential, prospective holding period and tax implications. The process of long term wealth optimization results in his ability to take that previously determined buy or sell decision and execute that decision in the optimal holding vehicle.

While the remainder of this description will focus on funds that would invest in equity or equity like instruments, TOPP Funds are applicable to fixed income securities, private placement offerings and any other tradable security in the markets. The term “manager” refers to the entity that holds the investment management contract for the pair of funds. That entity can then allocate responsibility to one individual, or a group of individuals, but the nuance is that the decisions ultimately made for the pair of funds are driven by prospective long term wealth optimization.

Using any combination of currently available publicly offered or privately managed funds, there is no known opportunity for any investor, let alone a relatively small investor, to realize the same potential returns with both taxable and tax-deferred monies that could accrue from TOPP Funds (assuming equal selection of securities for investment).

### DETAILED DESCRIPTION OF THE INVENTION

A pair of closed end funds, referred to herein as a “Total Optimized Portfolio Performance” pair (TOPP) launched simultaneously (or within a reasonable time frame from one another) are the vehicles by which the process of the invention operates. One of the funds (referred to herein as PAA or Personal Account Asset) will be positioned as a fund geared for investors to invest with “taxable” assets, or those subject to current taxation. The other fund (referred to herein as RAA or Retirement Account Asset) will be positioned as a fund geared for investors to invest with “tax deferred” assets, or those in which tax liability is deferred such as an IRA or 401k.

The simple definition of a closed-end fund is a fund that is underwritten (similar to the initial public offering that an operating company might go through) such that a finite dollar amount of cash is raised to be invested, and therefore a finite amount of shares are created. The shares of the Fund are then “listed” on a national exchange (NYSE, Amex etc.) An individual who purchases such shares on the IPO and then wants to dispose of said shares, will have to sell them through a broker much like any stock transaction occurs. Persons who want to purchase or sell shares after the IPO would also purchase or sell those shares through a broker.

Since these closed end funds will be listed securities, the RAA Fund will optimally be held by persons having self-directed IRA accounts. While the actual RAA Fund will not itself be a tax deferred vehicle, it will be positioned as a fund to be held WITHIN a tax deferred account, such as a self-directed IRA account.

The unique aspect of these funds is that while they are distinct legal entities from a 1940 Act perspective, they will be managed by the same investment manager. The manager, when making investment decisions, will determine which fund is the ideal recipient from a wealth optimization perspective, for the security he/she wants to purchase or sell. Since these Funds will be separate legal entities, there is no obligation for a holder to own both the PAA and the RAA Fund, nor is there any obligation for the holder to own a particular percentage of each fund. Having said that, the Hypothetical Investor who chooses to purchase both funds upon their offering (or at anytime in the future) would own a combined portfolio that encompasses ALL of the investment ideas of the manager, yet is optimized to take advantage of the difference in tax treatment afforded both taxable and tax deferred monies. The goal of the TOPP Funds is to optimize the total lifetime return on personal investment capital. This is partly accomplished by optimizing the total after-taxes (current taxes as well as prospective taxes) growth of assets for the Hypothetical Investor as well as his heirs.

The term “after tax” is traditionally used to reflect the returns generated by an investment after the payment of current tax due (such as current income tax, or capital gains tax on realized gains). Here, the term “after-taxES” is used to reflect ALL taxes, both current and future, which might be due on an investment. Therefore “after-taxes” includes current income tax and capital gain taxes on realized gains, but importantly includes in its calculation future tax liabilities resulting in mandatory withdrawals of IRA assets after a certain age.

The term “manager” refers to the entity that holds the investment management contract for the pair of funds. That entity can then allocate responsibility to one individual, or a group of individuals, but the nuance is that the decisions ultimately made for the pair of funds are driven by prospective wealth optimization. And, while the remainder of this discussion will focus on funds that would invest in equity or equity-like instruments, TOPP Funds are applicable to fixed income securities, private placement offerings and any other tradable security in the markets.

The importance of the optimizing between taxable and tax-deferred assets is addressed more fully below. As an initial example, the purchase of a security whose prospective tenure within a portfolio is less than a year should be purchased in a RAA Fund, while the purchase of a security whose prospective tenure will be years, if not decades, should be purchased in the PAA Fund. In addition, a security where much of the return comes from the generation of current, taxable income (such as a REIT or a Master Limited Partnership (MLP)) should be purchased in a RAA Fund, while a security whose return comes purely from price appreciation should, in general, be purchased in a PAA Fund (depending upon its prospective holding period).

For clarity of discussion, the references to profits from investments in the RAA Fund being “tax deferred” are not technically accurate. Since the RAA

Fund is a closed end fund, the tax liabilities generated by the buying and selling of securities within the RAA Fund must flow through to the underlying shareholders. The tax deferral aspect comes from the fact that the RAA Fund is positioned/offered as an effective vehicle to invest assets within a tax deferred account (such as a self directed IRA). The prospectus language will be quite explicit; pointing out that owning a RAA Fund in a taxable account might have extremely negative tax implications for the owner. Whenever the term “tax deferred” is used in the context of the RAA Fund, one could include the more expansive verbiage that “the profits are tax deferred if the shareholder holds the RAA Fund in a tax deferred account (such as a self directed IRA) such that gains reported (both short and long term) by the RAA Fund do not generate current tax liabilities.”

Location optimization of investments (whether an asset is held in a taxable account or a tax-differed account) is an important, yet often overlooked element of overall wealth optimization. Many investors erroneously assume that just because you should maximize the amount of assets you can place into an IRA or other tax deferred vehicle, that all assets are better in an IRA than in a taxable account. Accepted wisdom posits that deferring taxes is always better than paying them. While in many instances this may be correct, since many people have significant wealth in their taxable accounts as well, how they allocate the assets amongst those two “buckets” of savings is almost as important as the deferral process itself. Unfortunately, most people only look at the current deferral of taxes and do not take into consideration the substantial tax liability that builds within IRAs that start to become due after age 70½ when mandatory IRA withdrawals must occur, nor do they consider the favorable tax treatment that occurs upon death. Since the estate tax is becoming a non-event for more and more people, holding selected securities in a taxable account is actually more tax efficient than holding them in an IRA. TOPP Funds can help investors achieve this goal.

For ease of discussion, tax deferred assets are referred to herein as IRA assets. Yet 401k plans, deferred compensation plans, and other tax-deferred vehicles present the same issues for an investor, and the TOPP Funds solve those issues as well.

The following single stock example helps illustrate how location optimization can help an investor. Assume there is a Hypothetical Investor named Mr. HypIn, and assume Mr. HypIn is 50 years old and he will live to be 80. Assume as well that there is a stock, ABCorp, whose price, it is believed, will compound at 12% per year for the next 30 years. If Mr. HypIn invests $100,000 in this security at the beginning of year one when he turns 50, by the time he reaches his 70^{th} birthday this security will be worth close to $1,000,000. If this security resides in his IRA, he will then have to start liquidating it at age 70 (Technically, IRA withdrawals occur beginning in the calendar year following the attainment of age 70 and ½, but 70 is a round number for ease of explanation).

Assume that at age 70, actuarially his life expectancy is 15 years, and his beneficiary's actuarial life expectancy is 45 years. Therefore, he will have to withdraw funds at 1/30^{th} of the value of the security in year one, and withdraw an ever increasing percentage every year for the rest of his life. (Many IRA holders understandably list their spouse as their beneficiary. If that spouse is of the same approximate age and therefore has the same approximate life expectancy the mandatory withdrawals will be significantly higher.) Assume as well that his combined federal and state income tax rate is 40%. For comparative purposes, assume that Mr. HypIn purchased the same amount of ABCorp for his taxable brokerage account. After 20 years, the value in this account is also about $1,000,000. It is over the course of the next 10 years that the value to Mr. HypIn and his heirs changes dramatically. At age 80, the security in the brokerage account has grown in value to be close to $3 million. In the IRA account, due to the taxes paid out on the mandatory required withdrawals, as well as the opportunity cost of not being able to invest those lost taxes paid, the total value of the IRA plus the after-tax remains that were reinvested in ABCorp are only worth about $2.5 million, or a full $500,000 less.

Assume that Mr. HypIn dies at age 80 and, as is currently legislated, there is no estate tax payable. Favorably, the tax basis of the ABCorp stock held in his brokerage account will be stepped up to the value at the date of death (in this example about $3,000,000). Therefore his heirs will then have $3 million to invest as they wish. If they choose to sell the stock at that time, there will be no capital gains tax due. Conversely, the assets of the IRA will only be worth $2.5 million, and will still have a tax liability associated with them. In fact, if the heir took the 2 “buckets” of assets, and invested them in a security that would compound at 12% for the next 20 years (the heir's then current life expectancy), by the time the heir dies in 20 years the value of the IRA assets would be worth about $11 million while the security in the “taxable account” would be worth almost $26 million. (This figure includes the assets that still remain in the IRA account, as well as the assets remaining from the mandatory withdrawals less the taxes paid on those withdrawals. For purposes of comparison, those assets were assumed to have grown at the same rate as the assets still inside the IRA as well as inside the taxable account.) Assuming no change in the estate tax system, that security will then have completely avoided taxation, since the heirs of the original heir to Mr. HypIn will also not have to pay any taxes.

While the above example assumes that an investor will be able to find investments that effectively compound at 12% for 50 years, the difference in family wealth between putting an initial $100,000 investment in an IRA and putting it in a “taxable account” is pronounced. This difference should be recognized and not ignored but more importantly should be actively embraced, which can be accomplished best through the use of TOPP Funds.

Referring now to the components of TOPP Funds, the tax efficiency of a closed end fund is driven by the decisions of the portfolio manager, as well as the decisions of the shareholder, who can trigger a tax event by selling shares. Heretofore there have been closed end funds that are geared towards maximizing current income, others geared towards maximizing total return (without regard to taxation) and still others geared towards providing a steady stream of income. But no one has offered two funds simultaneously to maximize the total tax affected wealth creation by optimizing the individual decisions made by a single manager into the optimal vehicle.

With TOPP Funds, the investment manager is charged with making two decisions. The first is similar to what he has been doing his entire career: making the decision to buy or sell a security. The second decision is unique to the process followed by a TOPP manager: “Which fund is the optimal repository for this idea?” While the answer might not always be clear, in many instances it will be clear, and when it is not clear, the answer can be “in both funds”.

While the following is by no means an exhaustive list of potential securities TOPP Funds might be involved with, it reveals the unique and flexible attributes of providing investment returns through a structure that seeks to optimize total after-taxes total returns. The assumption throughout, is that the portfolio manager is correct in what he believes will happen to the investment. Given that the PM is human, by definition, he will not be correct all of the time. But by giving him a pair of vehicles to optimize both aspects of that decision-making, the portfolio manager can provide the Hypothetical Investor who owns both TOPP Funds the potential to considerably improve after-taxes family wealth creation that is heretofore been unavailable.

Growth equities. For the purpose of this discussion, a growth equity is the stock of a company whose revenues/earnings/cash flow per share is expected to grow at a double digit rate for at least 5, if not 10 years or more. No differentiation in market capitalization is assumed.

While it is possible to buy a “growth equity” that is also intrinsically cheap (see value equity discussion below) it is more likely that the market has recognized at least part of the growth potential, and therefore the stock may be termed “expensive” on a current metric basis (current metrics might be price/earnings ratio on the current year's estimated earnings, or Trailing Twelve Month (TTM) earnings or sales ratios). Historically, true growth equities are often cheap on these same metrics the company achieves in years 2, 3 or 4, but due to the conservative nature of published earnings “estimates” they are viewed as expensive. For example, most investors would consider a P/E ratio of about 7 to be a very “cheap” stock, especially when the earnings are growing at a double-digit rate. Google (ticker GOOG) launched its IPO in the late summer of 2004, at a price of about $85 per share. While it popped to $100 fairly rapidly, an investor had almost 2 months where he could have purchased GOOG at or around $100/share. Three years after the GOOG IPO, the company earnings are at least $15/share, or about $12 on a TTM basis. Dividing $100 by $15 you get a P/E ratio of about 6.6 times, or dividing by $12, a little over 8 times. So in 2004 GOOG could be purchased for about 7 times the three-year forward earnings, even though Wall Street considered GOOG a very expensive stock at the time.

Of course there are multiple examples of companies whose shares appear reasonably valued (or in fact “cheap”) on “out year” earnings expectations, but are in reality very expensive on out year earnings, since the earnings growth never materializes.

Buying growth equities. Because of the nature of their risk and return, in general “growth equities”, should be purchased in a PAA Fund within a TOPP pair. Assuming that the manager believes that the shares are in fact “cheap” on out-year earnings, he is making the implicit “bet” that he will want to own the shares for at least three to five, if not more years. If the stock turns out to be a consistently high performer, then the manager will want to own those shares for years, if not decades. The compounding valuation is more appropriately held in a taxable account, and if held till death, all taxes will be avoided. Even if the manager decides to sell the stock after only five years, on an after-tax basis, the investor in the PAA Fund is usually better off paying the lower capital gains tax after five years, than deferring what might be a 40%+tax in future years. (This is dependant upon the age of the investor when the gain is realized as well as his life expectancy)

If the stock does not live up to its growth expectations, and in fact was expensive at the time of purchase, then it is highly likely that the value of the shares will drop. If such a security were held in a RAA Fund, there would be NO tax advantage accrued from selling the shares. Whereas in a PAA Fund, the PM will be able to utilize the tax-loss incurred to offset other gains, either within the current tax year or carry them into future tax years.

Selling growth equities. Assuming that a security that was considered to be a “growth equity” (with high expectations for future growth) is determined by the manager to have lost its growth prospects, then the manager is likely to sell the shares owned in the PAA Fund and realize the tax loss. The manager could also sell the shares in the RAA Fund. Since the shares were probably not owned in the TD Fund to start with, this sale would be a short sale, which when closed out profitably in the future would be not be taxed at a short term rate, but rather deferred (assuming of course that the RAA Fund is held within a self directed IRA account).

Value equities. For this discussion, a value equity is an equity whose intrinsic value is more than the value ascribed to it by the market. This intrinsic value may be the result of assets that the company owns that are not fully deployed in the present, but might be better deployed in the future. Intrinsic value may be that the company is less profitable as an independent public company, and may be worth more to either a private buyer, or a larger public entity. Intrinsic value may be higher because there is a very public issue (lawsuit, patent expiration, slow current demand etc.) that the current market is concerned about, but an astute investor might believe is overly discounted in the price of the stock. Often the passing of time is all that is needed for the market to recognize this extreme discount situation. No differentiation in market capitalization is assumed.

Buying value equities. Under this definition of a value equity, not only is it merely a matter of time before the market recognizes the inherent value in the shares, but also that the “value” of the shares is already discounted heavily by the market. Under this assumption, while the stock might not go up much in the short term, it is also not likely to go down much further. Therefore, this type of equity is an ideal candidate to be purchased in a RAA Fund. The holding period is relatively short, and the downside risk is modest.

Selling value equities. The portfolio manager would love for the market to recognize the intrinsic value he sees in the shares the day after he has completed purchasing his full position, but reality is that this value recognition might take weeks if not months or quarters. Since the shares are held in the RAA Fund, the tax implication for the underlying shareholder is optimized regardless of when the value recognition occurs.

If the value recognition does not occur, and the TOPP manager sells the shares, it is more than likely that the tax loss, if any, would be small, so that the inability to utilize that tax-loss (from a RAA Fund) is relatively inconsequential. There might be other examples, where some investors believe that the downside risk is minimal, whereas the TOPP manager believes otherwise. As with a “broken” growth stock, the manager will have the ability to sell the shares short in the RAA Fund (discussed below), where the ultimate shareholder's ability to defer the tax will be present.

Other equities. For this discussion, these are equities that the manager finds attractive but whose obvious placement in either the PAA or RAA Fund is less clear. An example of this might be a growth equity that has fallen out of favor. The manager believes that the market has overly penalized the stock, and therefore it has “value” attributes. In addition, if the growth potential that investors formerly saw reestablishes itself, then perhaps the stock can be held for a long period of time. But since it may not have the intrinsic value of a value stock, the downside risk might be greater.

Buying. Since the anticipated holding period might not be obvious to the PM upon purchase, and the downside risk might still be significant, the TOPP manager might decide to purchase the stock in both the PAA and the RAA Funds.

Selling. Similar to the above examples, where the sell decision was slightly different for the two different funds, the sell decision here should be based upon the prospective holing of the security going forward as well as the tax implication of the actual sale. If a security that is in both the TD and PA Funds is successful (it goes up in value), and the TOPP manager is nervous about the next earnings announcement, he might decide to sell or trim the shares that were held in the RAA Fund, since the tax implications are optimized, whereas he might decide not to sell the shares held in the PAA Fund since the realization of a potentially short term tax gain is sub-optimal. Conversely, if the stock is not successful in the short term (it went down in value) the TOPP manager would be inclined to sell the shares in the PAA Fund and realize the tax loss benefits for the underlying shareholder of the fund whereas he might not sell those shares in the RAA Fund, since no tax benefits are realized by the sale.

Trades. These may be viewed as “positions” initiated by the TOPP manager that by definition are short-term in nature. They are not “investments,” but rather a form of “bet” on whether an issue will rise or fall in value.

Buying. Since the definition of a “trade” is something that will be put in place on day 1, minute 1 that might be reversed anywhere from day 1 minute 2 all the way to perhaps day 30 or day 60, (but more than likely not held for over a year) it is highly optimal to execute such short term trades in a RAA Fund.

Selling. Much like the analysis in the selling of “value equities” cited above, the closing out of a successful “trade” in a RAA Fund will be optimized for tax purposes versus one executed in a PAA Fund. Of course, a “trade” can also be the initiation of a short position (see below), that the TOPP manager believes will be profitable, again optimized if implemented in the RAA Fund.

REITs & MLPs. Real Estate Investment Trusts and Master Limited Partnerships are both tax-advantaged structures (to the entity) that trade like stocks. A REIT is a collection of real estate assets managed by the REIT operators and in most instances the underlying real estate throws off cash in the form of rent etc. An MLP is a collection of other physical assets (such as oil or gas reserves, cargo ships etc.) that also throw off cash in the form of royalties etc. The tax advantage that these entities possess is that the REIT or MLP pays no income tax on their profits, but rather the holder of a share of the REIT or MLP is responsible for the payment of taxes on his allocated portion of profits.

Buying. While the dividends of taxpaying corporations domiciled in the U.S. are eligible for preferred tax treatment (because the corporation already paid profits tax), the dividends (or at least the profit portion) of REITs or MLPs receive no such preferential treatment. Given that, historically, a high percentage of the total return of these “equities” has come in the form of dividends (that are taxable at a recipient's marginal income tax rate), these are ideal “equities” to be held in a RAA Fund, where the tax liability can be deferred.

Selling. Similar to the discussion of the other types of “equities,” the profitable realization of a REIT or MLP investment held in a RAA Fund will defer the tax liability. In addition, since REITs and MLPs are valued on their dividend flow compared to market rates on other income producing assets such as bonds, the value of the shares have historically moved inversely to the direction of interest rate changes. If the PM believes that interest rates are rising, he may initiate short positions in REITs or MLPs in an attempt to profit from those interest rate moves. In general, short positions are better placed in the RAA Fund as well, since profits are always considered short term for tax purposes.

Option—as insurance, or to create a position.

Options are a sophisticated tool for enhancing total return. This “enhancement” can be in the form of exposing the portfolio to more profit potential with less total capital at risk (i.e. buying calls); or to “protect” the portfolio from adverse price action (i.e. buying puts). Selling a call can be a form of income enhancement, while selling puts can be a hedged method of increasing potential exposure at lower levels while at the same time generating current income from the sale of the option. The decision process for a TOPP PM to determine whether to buy or sell an option is no different than if he were not managing TOPP Funds, what IS different is his ability to implement that trade within the most tax optimized vehicle.

Unlike in the case of the aforementioned equities, where it is always assumed that a position will be profitable, sometimes the use of options occurs when insurance against adverse price movements is desired. Much like buying life insurance; the TOPP Manager is hoping that the insurance doesn't pay out! So on an individual decision basis, the TOPP Manager will determine the likelihood of profits from the options transaction, as well as the length of time before expiration date. Once those are determined, he can determine what fund (from a tax optimized perspective) is the ideal recipient for that position. The examples below are general in nature and not intended to encompass all iterations of option transactions, yet by going through some of them, one can see how TOPP Funds can optimize the use of these important investment vehicles, and therefore optimize total lifetime wealth.

Calls Calls give the owner of a call the opportunity to buy shares at a given strike price. If the current price of the stock is below the strike price of the option, then the option is “out of the money”. If a fund manager wants to buy shares (either as a new position, or to enhance a position already owned) but is nervous that the timing might not be correct (since perhaps the stock has already appreciated substantially), instead of paying $28 for a share of stock, he might pay $1 for a $30 “out of the money” call that expires in 6 months. If the stock continues to appreciate, the value of the call should also appreciate, but less on a share for share basis. Conversely, if the stock tumbles, the option will lose value, yet the fund will lose less on a share for share basis having bought the call rather than underlying stock. Such a call purchase is ideally implemented in a TOPP PAA Fund. If the stock appreciates dramatically, the TOPP Manager can exercise the call option, effectively converting a short term options gain into a potential long term holding (thus deferring any tax impact). Conversely, if the underlying equity falls, the TOPP Manager can either sell the call at a loss and harvest the tax loss, or let the option expire, which also gives rise to a short term loss.

Perhaps the TOPP Manager has looked at the appreciation this same equity has experienced, and instead of buying a call anticipating further appreciation, he wants to sell a call to book income because he believes the stock is poised to give back some of its recent gains. He might prefer selling the call rather than shorting the stock. If the stock does indeed fall, the call will expire worthless, providing a short term gain for the fund. Obviously, it would be optimized to have sold this call in the RAA Fund, rather than the PAA Fund. If the stock continues to climb, the TOPP Manager has the choice of repurchasing the call to minimize the loss, or, since he can short in a closed end fund, allow the call to be exercised (effectively creating a short position). If that short position is eventually profitable, the gain on that position will be tax deferred to the ultimate owners of the RAA Fund.

Puts. Puts give the owner of this type of option the ability to “put” shares to the seller of the put at given strike price. If the current price of the stock is above the strike price of the put, then the option is “out of the money”. Puts can be used as insurance against an adverse price movement, or as an offensive position to gain in the event of a price decline. In the former example, the TOPP Manager is concerned that a position in one of the PAA or RAA portfolio is susceptible to some weakness. Assume the stock is at $32. If he sells the stock he might trigger a taxable event (if the stock was held in the PAA Fund), but perhaps more importantly, if he sells the stock and the news that comes out is unexpectedly positive, his hypothetical investor will have no position in the security.

For example, the stock is trading at $32 and he buys a $30 put with about 1 month till expiration. Cost of the put is about $1. Since this is an “insurance” option (i.e. the PM doesn't really think he will need it . . . like most 40 year olds don't need life insurance) the purchase of the put is best implemented in the PAA Fund, since the PM is really hoping that the option will expire worthless because the stock is going UP. By purchasing the put in the PAA Fund, the underlying shareholder will receive a tax benefit if/when it expires worthless. If, on the other hand, the PM has conviction that the shares will decline, then the purchase of this put should take place in the RAA Fund, since the anticipated gain on the position will be tax optimized.

Some options have very long expiration periods (over one year till expiration; also referred to as LEAPs). The purchase of a LEAP “put” in a PA Fund is the only way to profit from the decline in the price of a stock in a quasi tax advantaged fashion. Since the purchase of a put is a “long” investment (as opposed to being short the underlying security), there are instances where it makes sense to buy a put in a PAA. Assume the stock is at $45, and the PAA Fund buys a 2 year $35 put for $1. If, after 11 months the stock price has gone down, the LEAP will probably have gone up in value. In this instance the PA Fund will keep the security at least until it becomes a long term gain. If, on the other hand, the stock has stayed flat, or in fact gone up, then the LEAP will have lost value, and the PAA Fund can sell the LEAP at a loss and harvest the tax loss.

Another example of using puts is to sell an out of the money put, rather than buying more of the underlying shares. For example, the TOPP Manager might have a position in a stock, but wants to buy more. Ideally, he would like to buy the additional shares about 10% cheaper than the current market price. Assume that the stock is at $33 and he wants to buy more at $30. If he does nothing, and the stock continues to appreciate, he will have lost out on incremental profit potential. But perhaps he can sell $30 puts for $1.

If the stock goes up, while he will not have owned more of the security, the short put will expire worthless, and the fund will have earned the $1 of premium. If the stock, does in fact drop to $30, the put will be exercised, and the fund will be obligated to buy shares at $30 (where the TOPP Manager wanted to buy them in the first place) and will also have earned the $1 of premium. Obviously, if the shares go to $29, the fund will be put shares at $30, and the premium earned will be a wash; or if the shares drop to $27, the fund will have effectively bought at $29 (the $30 price less the $1 premium from the option that was sold), but this is actually a better price than the PM's original target purchase price of $30. If the put was sold short in the RAA Fund, and the option expired worthless, the tax gain would be optimized. Conversely, if the put was sold short in the PAA Fund, it would be a taxable gain.

Warrants Unlike publicly traded options that are not on the balance sheet of a company, a warrant is usually issued by a company, often in conjunction with a separate raising of capital. For example, a company may do an underwriting of equity (either the IPO or a secondary offering) and as an added inducement for investors to buy equity at say $20/share, a warrant will be attached that enables the investor to potentially buy more shares at say $25. If the warrant has an expiration date of 8 years, it may have significant value. In most of these instances, the warrants will then trade separately from the common stock.

A TOPP Manager may want to buy a warrant for one of 2 reasons: as a leveraged way to participate in the short term price movement of the stock with potentially less capital at risk than buying the underlying equity; or to establish a leveraged position in anticipation of the stock appreciating over the long run.

The term leverage here is based on the notion that buying an option (in this example, a warrant) is a leveraged investment without borrowing money. In an extreme case, a fund manager could decide to buy 1,000 shares of a stock for $30/share; a $30,000 investment. Conversely, he could decide to use that same $30,000 and buy 10,000 warrants for $3 each, with each warrant giving the right to buy stock from the company at $35/share. Assuming that the warrant has 3 years till expiration. If expiration is now approaching and the stock is trading at $35, the stock investment would be worth $35,000, while the warrant will probably expire worthless, for a loss of $30,000. If, however the stock is $40, the stock investment would be worth $40,000, while the warrant investment would be worth $50,000 ($5 per warrant times 10,000) Where the real “leverage” arises, is if the stock has in fact doubled to $60, such that the stock investment has gone up 100% to $60,000, but the warrant investment is now worth $250,000 ($25 per warrant times 10,000). A fund manager may not use the entire $30,000 to buy warrants, but rather $10,000. If the stock goes nowhere the fund has only lost $10,000, while if the stock doubles the warrants will be worth close to $85,000; a leveraged position.

Even though the warrant may have over a year (if not 5 years) till expiration, wealth optimization will be driven by the anticipated holding period of the warrant. If the TOPP Manager believes it is a short term holding, then more than likely it should be purchased in the RAA Fund. If, however, the TOPP Manager wants to own it until expiration, then it is probably optimal to own it in the PAA Fund. Of course, the third option is to buy it in both. As outlined above under “Other Equities”, the TOPP Manager could buy it in both; if it appreciates in the short term, he can sell it from the RAA Fund without immediate tax implication. If it has dropped in value in the short term, he can sell in from the PAA Fund and harvest the tax loss. It is also possible to short warrants, and then it is probably more favorable to short them in the RAA Fund.

Convertibles Convertible securities (both convertible bonds and convertible preferred stocks) are actually a hybrid security combining current income like a bond, with a long dated call feature like a LEAP or a warrant. In exchange for providing capital for the issuer, a convertible buyer holds a fixed income instrument that pays a pre-established or fixed dividend, and then has the ability to exchange the convertible for common shares at any time until maturity. While the payment of the convertible dividend is not guaranteed, unless the business prospects are bleak enough to cause the balance sheet to deteriorate dramatically, convertible dividends have fairly high priority for the company to fulfill. The exchange ratio is set such that the stock needs to appreciate a fair amount before a rational investor would convert into common.

As an example, assume that a company's equity is trading at $30/share (and the common stock pays no dividends), the company might float a convertible offering such that the holder pays $30 per convert share, and receives $1 per annum in dividends. So as a fixed income security, this would yield 3.3%. If the company were to issue bonds, they might have to pay a 6.6% yield (given their credit rating). As an inducement to accept this lower yield, the convert buyer will have the option to convert into 0.75 shares of common at anytime during the next 8 years. Calculating that through, the equity will have to appreciate to $40 before that conversion might make sense; therefore this is referred to as a 33% conversion premium (the stock has to go up 33%) In general, the dividends paid by converts are not considered “qualified”.

“Qualified” dividends enable the recipient of those dividends to pay a reduced income tax rate on the cash received. While there are certain holding restrictions vis a vis how long the security has been held prior to the dividend payout in order to be “qualified”, the tax code rationale for having “qualified” dividends receive preferential tax treatment is that the funds used by the company to pay out those dividends have already been subject to corporate income taxes. Therefore the recipient should not have to pay full personal tax rates on those monies. While corporations are not allowed to deduct the cost of dividends to common stock holders against the company's income, in certain circumstances corporations CAN characterize the payment of Convertible dividends as interest paid. If the corporation chooses to deduct the payments to lower the corporation's tax liabilities, then the recipient of those dividends cannot characterize them as “qualified”; thus subjecting the recipient to a tax burden equal to his/her marginal income tax rate.

In the majority of cases, as a standalone investment with the downside risk protected by the yield of the convert, and the income from the convert fully taxed, it would make sense for the convert to be held in a RAA Fund. But as pointed out before, it is possible to view converts as a hybrid: a bond with a LEAP or warrant attached. As noted under the discussion of LEAPs and warrants, depending upon the anticipated holding period, it may make more sense to hold them in a PAA. In fact, in the above simple example the value of the bond component is $15 per share (at $15 the piece of paper is equal to a bond offering by the same company since it will then yield 6%) therefore, the option or warrant value of the convert is also $15. Hypothetically, it would be advantageous to hold the bond component of the convert in the TOPP RAA Fund, while holding the option component in the PAA Fund. At a minimum, the TOPP Manager could synthetically isolate the respective components into the optimized fund such that the Hypothetical Investor who owns both the PAA and RAA Funds will be indifferent from a pre-tax economic value, but the after current and prospective tax returns will be superior.

For example, the RAA Fund could buy the convertible on the open market, and have a third party value the option component. This third party could then be the intermediary between the RAA Fund shorting the option value while the PAA Fund buys the same option. Even though the RAA will be selling premium, that income will be tax deferred to the underlying shareholders (assuming of course it is held in a tax advantaged account) while the PAA Fund will own the option.

Once TOPP Funds become prevalent, it is conceivable that underwriters will create two-pronged convertible offerings such that the bond portions are sold to RAA Funds while the option components are placed in PAA Funds. This would eliminate the need to have third parties value the distinct pieces since the “market” would set the respective prices.

Leverage The concept of leverage is to magnify the potential gain on a security. In general, leverage can be acquired in two generic ways: through the redeployment of borrowed monies to purchase more of a given security, or by the purchase or sale of options. The risk profile of the two methods is different as well. As a simple example, assume that an investor with a $1 million worth of ABCorp borrowed an additional $300 k (using the stock as collateral) in order to buy more ABCorp. Also assume that the cost of borrowing the monies is 10% per annum. ABCorp rises 20% in 6 months. Had the investor not used leverage, his investment would be worth $1.2 million. Having levered, however, the value of the investment is now worth about $1.545 million ($1.3 up 20% ($1.56 million) less the cost of borrowing $300 k for half a year ($15 k)). If he then sold $300 k worth of ABCorp and paid down the leverage, the account would be worth $1.245 million, effectively improving his profit by $45 k (assume no taxes). If, however, the stock dropped 20%, without leverage the value would be $800,000, whereas with leverage it would be $725,000. So with success, leverage added $45 k extra, but with disappointment it detracted $75 k extra.

The other way to have levered is through the use of options. Instead of holding $1 million of ABCorp, assume he owns only $950,000 and uses the $50 k remainder to buy at the money options expiring in 6 months on ABCorp. If the stock goes up 20% then the value of those options have tripled and are now worth $150 k giving him a total value of $1.290 million, or a $90 k advantage over no leverage. If, however, the stock goes down 20% (and the options expire worthless) then the account is worth $760,000. This amount is still worse than no leverage, but better than with the use of borrowed monies. On the surface it might appear to always be advantageous to use options rather than borrowed funds, and in the case of extreme price action (as in this example) it usually is, but in the event of no change in price, financial leverage is superior. In this example, the unlevered example would still be worth $1 million, the levered example would have lost the $15 k in financing cost, but the options example would lose all the premium paid for the calls and be worth only $950,000.

As to which method is more appropriate for a PAA Fund versus a RAA Fund, the iterations are too numerous to list, but there are a few rules of thumb: The interest on borrowed funds will not be a passed through tax deduction in a RAA Fund, so in general, financial leverage makes more sense in a PAA Fund. The time to expiration of the option also plays into the calculation, as does the “in the money” status of the option. In general, short term options are better in the RAA Fund, with those longer than a year perhaps better suited for the PAA Fund.

Private Placements For the purposes of this discussion we will define private placements as non-registered investments in a non-public company, although most of the following could also pertain to private placements in public companies as well. The position along the capital structure hierarchy that a private placement can occupy can be anywhere from secured lending against assets (most seniority) to equity, or options/warrants on equity (least seniority). While private placements can be attractive investments, it is virtually “imprudent” to hold them in any open-ended investment vehicle, since by definition the ability to trade or even value them on a frequent basis is limited.

In an open-end vehicle, the fund manager might assess the risks of a given private placement to merit a small, say 2% position in the fund. If, however, due to “other people's actions” the fund shrinks due to redemptions, the remaining shareholders might be burdened with out-sized risk, since the PM cannot reduce the size of the position as the fund suffers redemption requests.

Therefore private placements are ideally suited for closed, or non open-end vehicles or funds (like TOPP Funds). Again, virtually by definition, private placements are usually structured on the assumption that the buyer will hold the investment for at least a year, if not 3-5 years (depending upon the success of the investment).

Again, by definition, a private placement is a privately negotiated transaction between a company and one investor or a small number of investors. It usually occurs because the company is in need of capital, and therefore, the investor(s) can negotiate terms as well as structure. Often, private placement transactions entail a package of securities that the investor(s) receive that might include a combination of secured and unsecured paper. As with the above discussion of convertible securities, the package may include debt-like paper as well as equity or option-like paper. While the company is concerned about both terms and structure, they are more than likely unconcerned about where the ultimate monies come from (i.e. placed in one “bucket” or in multiple “buckets”).

While there may need to be third-party fairness opinions necessary for the following to occur, it is conceivable that a TOPP manager can decide to invest in the “package” of securities offered in a private placement, but then allocate the individual components of that package to the PAA and RAA Funds based on location optimization. For example, the company is willing and able to do debt financing, but in exchange for a reasonable interest rate (that is probably significantly below what a bank might charge, given the company's credit quality) the TOPP manager demands warrants that will benefit his investors in the event that the company is successful, and perhaps goes public. From a tax optimization perspective, the interest bearing bond would ideally be placed in the RAA Fund, while the warrant would be better placed in the PAA Fund. If the company is successful, the RAA Fund will receive interest on the “bond”, and if the creditworthiness of the company dramatically improves, might even be able to sell the bond for dramatically more that the fund paid. The interest payments received will be tax deferred, and the gain on the appreciated value of the bond will be relatively modest. The PAA Fund, which optimally will hold the warrants, would see a huge gain due to the success of the company, but since that gain will probably take place over a period of 3-7 or more years, the tax implications will be muted. In fact, it is conceivable that the warrants that are eventually converted to equity could be held in the PAA Fund for decades.

Conversely, if the company is not successful, the warrants will become worthless, which provides a tax loss benefit to the PAA holders that would be wasted if held in the RAA Fund. If the company is not a total disappointment, the bond security that the RAA Fund holds might eventually realize a high percentage of cents on the dollar, since the assets of the company might be worth something to a strategic buyer. While the RAA Fund might suffer a loss, the magnitude of this loss should be muted, and thus this bond is optimally held in the RAA Fund.

Synthetic Securities We define a synthetic security as a “position” (either long or short) that is created or structured by a third party (usually a credit worthy intermediary like an investment banker or broker). The reason they are referred to as “synthetic” is that they are not created by, or an obligation of, a company (such as a common stock or bond might be), nor are they created by an exchange like a listed option might be. Due to the vast capital resources and breadth of holdings of selected intermediaries, they are able to “synthetically” sell to or buy from a sophisticated investor (creating a long or short investment for the buyer), a “security” that has certain performance characteristics. As an example, a buyer might want a security that pays off if the price of a commodity reaches a certain level, or, like a convertible, provides 80% of the upside participation of a given stock change but only 30% of the downside participation. While listed options require set strike prices and set expiration dates (for example, a long term call on a $30 stock might only be available at strike prices of $5 increments and expiring in January of next year and the year after). A synthetic call might be structured to expire in May three years from now, at a strike price of $42.

The intermediary may choose to take the opposite side of the transaction, or, due to their assessments of correlations, might choose to merely create a general liability. Since the synthetic is ultimately a credit of the intermediary, it is imperative that the intermediary be of the highest credit caliber.

Like converts, options and private placements, the iterations are too numerous to cite, but placing such securities in a RAA fund might be more advantageous than in a PAA Fund, or visa versa. For the Hypothetical Investor who owns both funds, allowing the TOPP Fund manager to optimize the placement of these securities in the most advantageous fund is truly unique.

Market Timing Market timing refers to the concept of attempting to profit from the market's inherent short-term volatility. For example, even though an investor believes in the long term health of the stock market, he believes that “the market” is overvalued, and susceptible to a correction of 20% over the next 3 months. He would rather raise cash, and stand on the sidelines a bit, and hopefully be able to repurchase shares after the correction has run its course. In order for a manager with taxable monies to implement this decision, he can either sell those stocks that have little or no gain to avoid realizing gains, or he can sell a certain percentage of EVERY holding in the portfolio regardless of gain realization. Murphy's law would posit that the “no gain” stocks he sold actually would go up in the market correction (perhaps because they had lagged so much before, thus their lack of unrealized gains) and the stocks he didn't sell are the ones that suffer. Since he is making a “market call” and not an individual stock call, he might want to choose to sell certain percentage from ALL stocks. If he were managing TOPP Funds, he would be able to sell every single stock in the RAA Fund without creating a tax liability for the ultimate shareholder and dramatically reduce the market exposure for the Hypothetical Investor who owns both funds. Again, the PM is making an investment decision, and then merely implementing that decision within the fund that optimizes wealth for the Hypothetical Investor.

Fixed Income Securities

Long Duration/Short Duration/Municipal Bonds/Original Discount Bonds/Market Discount Bonds/Preferred Stocks

As stated before, there are many iterations of equity and equity-like securities whose purchase and/or sale can be location optimized with TOPP Funds. While the following discussion of fixed income securities will be much more condensed, there are also ample opportunities to have TOPP Funds take advantage of the different tax treatment accorded different fixed income securities.

Most active fixed income managers are compensated on the total return of their funds, and are consequently tweaking their portfolios to change the duration of the portfolio in response to their views of the direction of interest rates, as well as the slope of the yield curve. Most times, however, that is done without regard to the tax implication of those changes. For example, if a PM believes that rates will be rising, he might want to shorten the duration by selling a long dated zero-coupon bond. That sale, however, if implemented in a taxable vehicle might result in a short-term realized gain that affects the investor's total return. Conversely, if the PM were managing fixed income TOPP Funds, where a Hypothetical Investor owned both the PAA and RAA Funds, the PM could sell the long duration zero coupon out of the RAA Fund (or in fact short it if the RAA fund did not own it) and the effective duration that the Hypothetical Investor would “own” would change, but his tax situation would be better. Conceivably the PAA Fund could have very little trading activity (or only activity that generated losses) while the RAA fund could be the vehicle where most of the decisions that the PM wants to make, are implemented. Again, TOPP Funds allow a PM to funnel his investment decisions to the vehicle that is wealth optimized to the ultimate investor.

Many investors purchase municipal bonds for their taxable accounts, but then the characteristics of that “portfolio” is viewed separately from the investor's overall fixed income exposure. Again, it is conceivable that a fixed income TOPP PAA can have a large percentage of tax-exempt bonds in it, but when the PM wants to buy a taxable bond, he can decide which TOPP Fund is the optimal recipient.

When zero-coupon bonds are issued, the future accretion of the discount is considered taxable income, even though the bond holder receives no cash (since it is a zero-coupon). So if the US Treasury were to sell a 10 year zero coupon bond at $75, the bond holder would have taxable income of about $2.50 per year which represents the straight line accretion of the $25 discount over the 10 year life. (Note: this is a Simplified Example; at Maturity the Bondholder would Receive $100.) Since the bond holder is receiving the benefit of the accretion, but yet receives no cash to pay taxes, it would potentially be more advantageous to hold such a bond in a RAA Fund.

If a company issues a par bond (issued at $100 with redemption value at maturity of $100), but yet due to either a change in the credit quality of the issuer, or a change in market interest rates (or both) the bond is now selling at a discount, the IRS treats the future accretion of this discount as a capital gain when realized. For example BondCorp issues a 20 year bond at par. Since their credit rating is AAA, they are able to sell it with a coupon of 5.5%. For the first year, market interest rates do not change much, and BondCorp remains a good credit. In year 2, however, a financial crisis hits the United Kingdom, where BondCorp has the majority of its operations, and the credit-quality of BondCorp deteriorates such that if they were to issue new 18 year debt, the market would require an 8% interest rate. Consequently, the value of these bonds slides to $80. In year three, while the financial crisis has been contained, inflation fears are bubbling, causing long term rates to rise. Since our example bonds still have 17 years of maturity left in them, their value deteriorates again, such that they are now selling at $60. A TOPP Fund manager now wants to buy the bonds, anticipating that BondCorp is still a solid credit, and believing that not only will he be receiving a 10% current yield on this investment, but also that eventually the bond will be worth par. This presents a curious choice for the TOPP PM, since if he puts it into the PAA Fund, the current high yield will be taxed at short term rates, but the capital appreciation portion will receive the advantage of being taxed at the capital gains rate. Much like a TOPP equity manager, the fixed income manager needs to assess the length of time he believes he will hold the piece of paper, and what the downside risks are (as well as the tax implications of the current yield). The shorter the anticipated holding period, the better it would be to be held in the RAA, while the “riskier” the security is, the better suited it is to be held in the PAA Fund. As with the “Other Equity” discussion above, a TOPP PM might decide to buy BondCorp's paper in both the RAA and PAA Funds, and manage the tax-optimization depending upon how successful the investment turns out to be. Another option would be to go to a third party who might synthetically separate the bond into 2 tranches: a senior tranche that would hold the capital appreciation portion (which would go into the PAA Fund) and an income tranche that would hold the income portion (which would ideally go into the RAA fund)

Finally, preferred stocks, while called stocks are really perpetual bonds issued by a company with a fixed interest rate. Because they have no maturity date, and because they fall lower on the capital structure than straight bonds, they have a tendency to have higher current yields than a bond from the same company. Since many preferred dividends are paid with a company's pre-tax income (and then the company takes a deduction for the cost) preferred dividends normally cannot be characterized as “qualified”. In general, preferred stocks would be better held in a TOPP RAA Fund, but not necessarily at all times.

Diversification. Diversification is an important investment tool, but like everything; too much of a good thing may not be better, and can even be detrimental. There is probably not a single investment professional that doesn't believe that diversification is important. But it's actually because of that virtually unanimous opinion, that diversification gets taken too far.

In order to understand this seemingly conflicted statement, one needs to understand the different levels of diversification. Investment risk diversification; personal risk diversification and business risk diversification. Unfortunately for the investor in pools (mutual funds etc.) or even those rich or fortunate to have individual customized advice, the confluence of these diversification motives provides a strong headwind to long term after-taxes returns.

Academic studies have long shown that a truly diversified portfolio of about 30 positions provides the vast majority of diversification's long-term benefits. While incremental positions improve diversification, the improvement is virtually unmeasurable, although more positions usually dampens the volatility of short-term results. Unfortunately this dampening of downside volatility also dampens upside volatility, which is otherwise known as “returns”. Given that evidence, why does the average open-end mutual fund hold well over 100 positions? To understand this, one needs to understand the other 2 aspects of diversification cited above: Personal Risk Diversification and Business Risk Diversification.

Personal Risk Diversification are the actions taken by individuals involved in the investment decision making process to mitigate their personal or perhaps better stated, career, risk. Assume simplistically that an Investment Management entity has one investment pool, call it the OpenEndFund, and the firm has a CEO, a portfolio manager, as well as 10 analysts who are charged with surfacing the best names in their respective areas of expertise. Each analyst does work on a large number of companies, and conceivably should be able to come up with the 3 BEST names that he/she wants the PM to put in OpenEndFund. But since each analyst is going to be measured on the success of his picks, for personal diversification purposes he wants to have many more than 3 names in the portfolio (after all 3 is not a “diversified” group of names). If each analyst pushes for 10 names, and the portfolio manager also has some choices that might not be covered or recommended by the analysts, the portfolio might end up with well over 100 names . . . all due to personal risk diversification.

Assume again, that the above PM has a list of 10 recommended stocks by each of 3 analysts (of the 10 total analysts), but because of his opinion on either the quality of the analysts or the sectors they are covering, he is very reluctant to invest in these names. But because the analysts are vociferous in their opinions, the CEO comes to the PM and asks “why don't you buy some of these names”? The PM is now put in a potentially no-win situation, with his career on the line. If he sticks by his investment convictions and doesn't buy the 30 names, and the 30 do well (or even SOME of them do well!) the CEO might blame him for not being a “team player” and cut his bonus or potentially fire him. If, on the other hand, he succumbs to the pressure and buys the names, and they do poorly, his performance will be affected, and the CEO may cut his bonus, or fire him for not having “conviction”, and underperforming. When there is no clear cut answer, it is more than likely that the PM will buy some or all of the names, but with smaller weightings than might be normal. Either way the result is over-diversification.

OpenEndFund has been a success for years, and even though the firm now manages other funds, it is now so huge that the management fee of OpenEndFund generates virtually all of the profit of the firm. The portfolio manager has generated these results because the fund has never looked like the market, having diversification, but not looking like the “benchmark”. Unfortunately it is now prudent (from a business risk perspective) for OpenEndFund to look a lot more like the market. After all, if the fund looks like the market it will perform in line with the market. Even though this change has occurred, the assets will probably stay, and if the market rises, the fees to the firm will also rise. But if the fund DOESN”T look like the market, and under-performs, the assets will shrink and the firm will have difficulty. So in order to mitigate or diversify the business risk, the fund acquires 100's of positions to effectively hug its benchmark, but again resulting in over-diversification.

Finally, when most individuals look at their taxable assets and then their tax-differed assets, they have a tendency to diversify BOTH pools, and often with different investment options within the same investment category. For example, the individual might choose 3 US equity funds from The FundGroup for his taxable savings, and then choose 3 US equity funds from AssetManagers Corp for his IRA assets. Assuming that all 3 funds each hold over 100 positions, the individual then has over 600 positions in US equities. Perhaps even more troublesome, is that one fund managed by AssetManagers may be buying a security that a PM for The FundGroup just sold at a profit in the taxable account. The investor's economic interest in the stock hasn't changed, but he is now saddled with a taxable gain that he needs to pay. So in an effort to follow the “apple pie” wisdom of diversification, at a minimum the investor has over-diversified leading to muted investment returns, or worse yet, incurred unnecessary tax liabilities due to the lack of tax-optimization in a separate multi-manager allocation structure.

Relative Size of the PAA and RAA Funds Upon Offering.

It is reasonable to believe that US general equity TOPP Funds could be launched with equal number of shares and price for both the PAA and RAA Funds since there are virtually an infinite number of securities, both original issue and synthetically created, that could be placed in each fund. But no rule applies in the context of the invention.

For example, assume there was an emerging market TOPP Fund offering planned. Given the risk profile of the emerging markets, and the relative dearth of securities that pay substantial dividends, it might make sense for the PAA Fund to be three times the size of the RAA Fund. In the fixed income arena, it might make sense to have the RAA Fund be three times the size of the PAA Fund, since a substantial portion of return from most fixed income investments comes from current income. Finally, the marketplace may dictate the size relationship of the 2 offerings. On an individual holder level there is a probably more “taxable” assets available than “tax-deferred” assets, such that the demand for a PAA Fund might be higher than that of a RAA fund. Conversely, since individuals who control “tax-deferred” assets can liquidate them without tax consequences in order to invest in a RAA Fund, and their “taxable” assets might have negative tax consequences, it is possible that the demand for a RAA Fund would be greater.

Regardless of the asset category (domestic equity, global equity, emerging market debt, private placements etc.), if individuals have pools of both taxable and tax-deferred assets to invest, they are better off optimizing their exposures to the individual asset classes through TOPP Funds. The relative size of those TOPP Funds will be a function of market demand.

1. A process for managing investment funds to realize the highest return after taxes, comprising:
establishing first and second distinct closed end funds, wherein a first of said funds is a personal account (PA) fund designed to be purchased with taxable monies, and a second of said funds is a tax deferred (TD) fund designed to be purchased with tax deferred monies;
designating a single investment manager for said funds;
managing investments in said funds separately from each other;
making buy and sell determinations on assets for each fund based on the manager's assessment of the prospective holding period of the asset and the characterization of income from and appreciation of the asset expected over time such that taxable gains and taxable income are minimized in the first fund;
recognizing tax losses in the first fund such that they can be employed to offset potential future gains;
thereby realizing the minimum tax burden on investment returns from both funds in both long and short taxation periods.

2. A process according to claim 1, wherein the first and second funds are established substantially simultaneously.

3. A process according to claim 1, wherein the first and second funds are distinct legal entities under the Investment Company Act of 1940.

4. A process according to claim 1, wherein the personal account fund invests in securities whose return is expected to result primarily from long-term price appreciation, and wherein the potential for individual security loss is high to permit potential realized losses to be employed to offset potential future gains.

5. A process according to claim 1, wherein the tax deferred fund invests primarily in securities whose return is expected to result primarily from the generation of current taxable income and short term capital gains, and wherein the potential for individual security loss is low.

6. A process according to claim 1, wherein the tax deferred fund is structured to be held within a tax deferred account.

7. A process according to claim 6, wherein the tax deferred account is at least one of a self-directed individual retirement account (IRA) and a 401(k) plan.

8. A process according to claim 1, wherein the investments in said funds comprise at least one of equity securities, fixed income securities, private placement offerings, and any tradable security.

9. A process for optimizing wealth realized from investments by managing investment funds to optimize total investment return, comprising:
establishing a plurality of distinct funds including at least a first closed end fund and a second closed end fund, wherein at least one of said funds is a personal account (PA) fund designed to be purchased with taxable monies, and at least one other of said funds is a tax deferred (TD) fund designed to be purchased with tax deferred monies;
placing the plurality of funds under the management of a single investment manager;
managing investments in said plurality of funds separately from each other;
making buy and sell determinations on assets for each fund based on the investment manager's objectives for performance of each fund over time in order to provide a desired balance between taxable gains and available tax losses to offset said taxable gains to result in minimum tax burden and maximum total investment return from the plurality of funds in a tax period.

10. A process according to claim 9, wherein buy and sell determinations are based in part on the investment manager's assessment of risk associated with an asset.

11. A process according to claim 9, wherein buy and sell determinations are based in part on the investment manager's assessment of potential return associated with an asset.

12. A process according to claim 9, wherein buy and sell determinations are based in part on the period of time an asset is expected to be held in one of said funds.

13. A process according to claim 9, wherein buy and sell determinations are based in part on the type of asset to be included in one of said funds.

14. A process according to claim 9, wherein buy and sell determinations are based in part on the investment manager's assessment of a combination of factors comprising at least one of risk associated with an asset, potential return associated with said asset, the period of time said asset is expected to be held, and the type of said asset.

15. A process according to claim 9, wherein individual investors are free to choose to invest in only a selected one of said funds or to invest simultaneously in more than one of said funds.

16. An investment method comprising launching a first closed end investment fund designed to be purchased with taxable monies and a second closed end investment fund designed to be purchased with tax deferred monies, said first and second funds being distinct from each other but being managed by a single investment manager for optimal return after taxes from the first and second funds when taken together over both short term and long term periods.

17. An investment method according to claim 16, wherein the investment manager's selection of assets for each fund is based in part on the investment manager's assessment of a combination of factors comprising at least one of risk associated with an asset, potential return associated with said asset, the period of time said asset is expected to be held, and the type of said asset.

18. An investment method according to claim 16, wherein the first and second funds are established substantially simultaneously as distinct legal entities under the Investment Company Act of 1940.

19. An investment method according to claim 16, wherein at least one fund is structured to be held within a tax deferred account.

20. A process for optimizing wealth realized from investments by managing investment funds to optimize total investment return, comprising:
establishing substantially simultaneously a plurality of funds as distinct legal entities under the Investment Company Act of 1940, the plurality of funds including at least a first closed end fund for investing in securities whose return is expected to result primarily from long-term price appreciation and a second closed end fund whose return is expected to result primarily from the generation of current taxable income and short term capital gains and where the potential for individual security loss is low;
placing the plurality of funds under the management of a single investment manager;
managing investments in said plurality of funds separately from each other;
making buy and sell determinations on assets for each fund based on the investment manager's assessment of a combination of factors comprising at least one of risk associated with an asset, potential return associated with said asset, the period of time said asset is expected to be held, and the type of said asset, in order to provide a desired balance between taxable gains and available tax losses to offset said taxable gains to result in minimum annual tax burden and maximum total investment return from the plurality of funds in a tax period.
